(19) United States
(12) Patent Application Publication
(10) Pub. No.: US 2026/0073888 A1
(43) Pub. Date: Mar. 12, 2026

(54) LIQUID CRYSTAL DISPLAY APPARATUS, METHOD OF CONTROLLING LIQUID CRYSTAL DISPLAY APPARATUS, AND ELECTRONIC APPARATUS

(71) Applicant: SEIKO EPSON CORPORATION, Tokyo (JP)

(72) Inventors: Kohei KOYAMA, MATSUMOTO-SHI (JP); Kazuhisa MIZUSAKO, SHIOJIRI-SHI (JP); Hayato KAWAMURA, MATSUMOTO-SHI (JP)

(73) Assignee: SEIKO EPSON CORPORATION, Tokyo (JP)

(21) Appl. No.: 19/321,318

(22) Filed: Sep. 8, 2025

(30) Foreign Application Priority Data
Sep. 9, 2024 (JP) 2024-154527

(51) Int. Cl. G09G 3/36; G09G 3/00

(52) U.S. Cl. CPC G09G 3/3688; G09G 3/002; G09G 3/3696; G09G 2310/027; G09G 2320/0209; G09G 2320/0271

(57) ABSTRACT

A display control circuit performs first correction on pixel data of video pixels based on the pixel data of two or more surrounding video pixels, determines whether both a voltage according to a gradation level of a video pixel of interest out of the pixel data on which the first correction was performed and a voltage according to a gradation level of a video pixel adjacent to the video pixel of interest are within an intermediate gradation range, performs second correction of cancelling out the first correction performed on the pixel data of the video pixel of interest when both the voltages are within the intermediate gradation range, and supplies the panel pixel with a data signal based on the pixel data on which the first correction was performed or, a data signal based on the pixel data on which the second correction was performed.

The present application is based on, and claims priority from JP Application Serial Number 2024-154527, filed Sep. 9, 2024, the disclosure of which is hereby incorporated by reference herein in its entirety.

### BACKGROUND

### 1. Technical Field

The present disclosure relates to a liquid crystal display apparatus, a method of controlling a liquid crystal display apparatus, and an electronic apparatus.

### 2. Related Art

As a reduction in size and high definition of a liquid crystal panel progress as in recent years, a gap between pixel electrodes narrows, and an influence of an electric field generated between the pixel electrodes adjacent to each other, that is, an electric field (lateral electric field) in a direction parallel to a substrate surface becomes nonnegligible. Specifically, an alignment failure of liquid crystal molecules called disclination occurs due to the lateral electric field, and is visually recognized as a defect on display.

For this reason, there has been proposed a technique of correcting video data supplied from a higher-level apparatus so as to reduce a difference between voltages applied to the pixel electrodes adjacent to each other when the lateral electric field becomes strong and it is expected that the display defect due to the disclination is visually recognized. Note that such correction may be referred to as disclination correction or domain correction in some cases (see, e.g., JP-A-2011-170235).

JP-A-2011-170235 is an example of the related art.

However, in such disclination correction as in the above technique, the correction of the video data supplied from the higher-level apparatus means that the display according to the video data is not performed, and there is a problem that a so-called display contradiction occurs.

### SUMMARY

A liquid crystal display apparatus according to an aspect of the present disclosure includes a liquid crystal panel including panel pixels, and a display control circuit configured to control the liquid crystal panel, wherein gradation levels of video pixels constituting video data are designated by pixel data, the video pixels include a first video pixel and a first adjacent video pixel adjacent to the first video pixel, and the display control circuit is configured to supply a data signal having a voltage based on a gradation level designated by the pixel data of the first video pixel to the panel pixel corresponding to the first video pixel, supply a data signal having a voltage based on a gradation level designated by the pixel data of the first adjacent video pixel to the panel pixel corresponding to the first adjacent video pixel, and make a voltage of a data signal supplied to the panel pixel in accordance with the first video pixel when both a gradation level designated by the pixel data of the first video pixel and a gradation level designated by the pixel data of the first adjacent video pixel are within an intermediate gradation range no lower than a first threshold gradation and no higher than a second threshold gradation, and a voltage of a data signal supplied to the panel pixel in accordance with the first video pixel when at least one of a gradation level of the first video pixel and a gradation level of the first adjacent video pixel is out of the intermediate gradation range different from each other.

A liquid crystal display apparatus according to another aspect includes a liquid crystal panel having panel pixels, and a display control circuit that controls the liquid crystal panel, wherein video pixels constituting video data are arranged in a first direction and a second direction, gradation levels of the video pixels are designated by pixel data, and the display control circuit is configured to perform first correction on the pixel data of one of the video pixels based on the pixel data of two or more of the video pixels adjacent in the first direction, a direction opposite to the first direction, the second direction, or a direction opposite to the second direction to the one of the video pixels, determine whether both a voltage according to a gradation level of the pixel data of a video pixel of interest out of the pixel data on which the first correction was performed, and a voltage according to a gradation level of the pixel data of a video pixel adjacent in the first direction or the second direction to the video pixel of interest out of the pixel data on which the first correction was performed are voltages within a first range, perform second correction of cancelling out the first correction performed on the pixel data of the video pixel of interest when both the voltages are within an intermediate gradation range no lower than a first threshold voltage and no higher than a second threshold voltage, and supply the panel pixel with a data signal based on the pixel data on which the first correction was performed or, when the second correction was performed, the pixel data on which the second correction was performed.

A method of controlling a liquid crystal display apparatus according to another aspect is a method of controlling a liquid crystal display apparatus including a liquid crystal panel including panel pixels, and a display control circuit configured to control the liquid crystal panel, wherein gradation levels of video pixels constituting video data are designated by pixel data, and the video pixels include a first video pixel and a first adjacent video pixel adjacent to the first video pixel, the method including supplying a data signal having a voltage based on a gradation level designated by the pixel data of the first video pixel to the panel pixel corresponding to the first video pixel, supplying a data signal having a voltage based on a gradation level designated by the pixel data of the first adjacent video pixel to the panel pixel corresponding to the first adjacent video pixel, and making a voltage of a data signal supplied to the panel pixel in accordance with the first video pixel when both a gradation level designated by the pixel data of the first video pixel and a gradation level designated by the pixel data of the first adjacent video pixel are within an intermediate gradation range no lower than a first threshold gradation and no higher than a second threshold gradation, and a voltage of a data signal supplied to the panel pixel in accordance with the first video pixel when at least one of a gradation level of the first video pixel and a gradation level of the first adjacent video pixel is out of the intermediate gradation range different from each other.

### BRIEF DESCRIPTION OF THE DRAWINGS

FIG. 1 is a diagram showing a projection display apparatus to which a liquid crystal display apparatus according to a first embodiment is applied.

FIG. 2 is a block diagram showing a configuration of the projection display apparatus.

FIG. 3 is a perspective view showing configuration of a liquid crystal panel in the projection display apparatus.

FIG. 4 is a cross-sectional view showing a structure of the liquid crystal panel.

FIG. 5 is a block diagram showing an electrical configuration of the liquid crystal panel.

FIG. 6 is a diagram showing a configuration of a pixel circuit in the liquid crystal panel.

FIG. 7 is a block diagram showing a configuration of a processing circuit in the projection display apparatus.

FIG. 8 is a diagram showing an example of a V-T characteristic in a liquid crystal element.

FIG. 9 is a diagram illustrating the disclination in the liquid crystal panel.

FIG. 10 is a diagram showing an example of filter coefficients of a smoothing circuit in the processing circuit.

FIG. 11 is a diagram showing examples of video pixels before and after the smoothing circuit is applied.

FIG. 12 is a diagram showing an example of a two-dimensional table of a restoration circuit in the processing circuit.

FIG. 13 is a diagram illustrating an operation of the processing circuit.

FIG. 14 is a diagram illustrating an operation of the processing circuit.

FIG. 15 is a diagram illustrating an operation of the processing circuit.

FIG. 16 is a flowchart illustrating an operation of the processing circuit.

FIG. 17 is a diagram showing a configuration of the processing circuit in the liquid crystal display apparatus according to the first embodiment.

FIG. 18 is a diagram illustrating an operation of the processing circuit.

FIG. 19 is a diagram illustrating an operation of the processing circuit.

FIG. 20 is a diagram illustrating an operation of the processing circuit.

FIG. 21 is a flowchart illustrating an operation of the processing circuit.

### DESCRIPTION OF EMBODIMENTS

A liquid crystal display apparatus according to an embodiment will hereinafter be described with reference to the drawings. Note that in the drawings, dimensions and scales of the elements are appropriately made different from actual ones. Further, the embodiment described below is a preferable specific example, and therefore various technically preferable limitations are imposed thereon, however, the scope of the present disclosure is not limited to the embodiment unless there is a description that the present disclosure is limited thereto in particular in the following description.

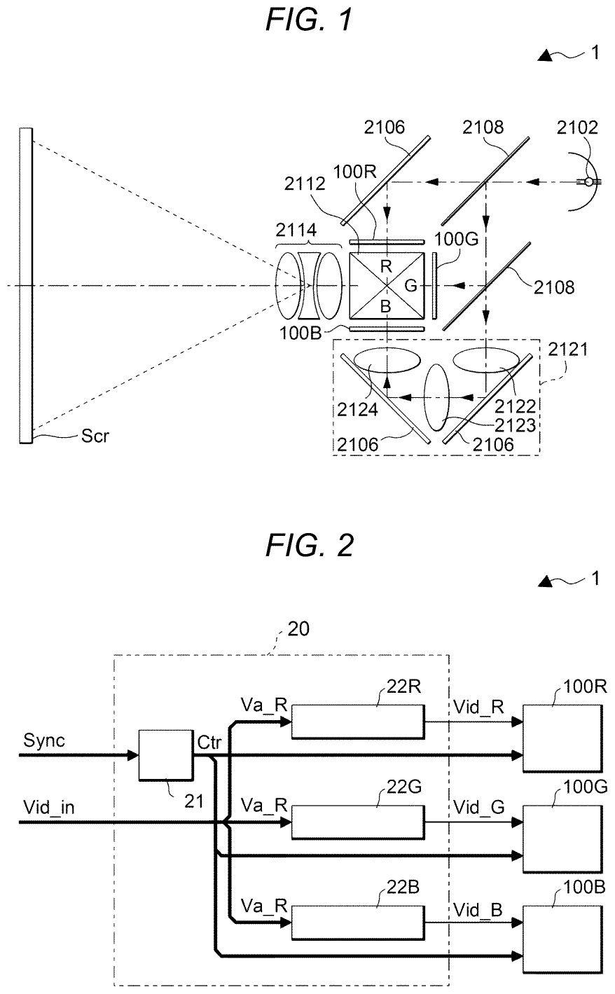

FIG. 1 is a diagram illustrating an optical configuration of a projection display apparatus 1 according to the embodiment. As shown in the drawing, the projection display apparatus 1 includes liquid crystal panels 100R, 100G, and 100B. A lamp unit 2102 formed of a white light source such as a halogen lamp or an LED is disposed inside the projection display apparatus 1. White light emitted from the lamp unit 2102 is separated into three primary colors of red (R), green (G), and blue (B) by three mirrors 2106 and two dichroic mirrors 2108 disposed inside. Among these, R light is incident on the liquid crystal panel 100R, G light is incident on the liquid crystal panel 100G, and B light is incident on the liquid crystal panel 100B, respectively.

Note that since a B optical path is longer than an R optical path and a G optical path, it is necessary to prevent a loss in the B optical path. Therefore, a relay lens system 2121 including an incident lens 2122, a relay lens 2123, and an exit lens 2124 is disposed on the B optical path.

The liquid crystal panel 100R includes pixel circuits arranged in a matrix as described later. In the pixel circuit described above, transmittance of light emitted from the liquid crystal element is controlled based on a data signal corresponding to R. That is, in the liquid crystal panel 100R, light emitted from the liquid crystal element functions as a minimum unit of an image. By such control, the liquid crystal panel 100R generates an R transmission image based on a data signal corresponding to R. Similarly, the liquid crystal panel 100G generates a G transmission image based on the data signal corresponding to G, and the liquid crystal panel 100B generates a B transmission image based on the data signal corresponding to B.

The transmission images of the respective colors respectively generated by the liquid crystal panels 100R, 100G, and 100B are incident on a dichroic prism 2112 from three directions. In the dichroic prism 2112, the R light and the B light are refracted by 90 degrees, while the G light travels straight. Accordingly, the dichroic prism 2112 combines the images of the respective colors. The combined image by the dichroic prism 2112 enters a projection lens 2114. The projection lens 2114 projects the combined image by the dichroic prism 2112 on a screen Scr in an enlarged manner.

Note that the transmission images of the liquid crystal panels 100R, 100B are projected after being reflected by the dichroic prism 2112, while the transmission image of the liquid crystal panel 100G is projected after traveling straight. Therefore, the transmission images of the liquid crystal panels 100R, 100B are in a horizontally-flipped relationship with respect to the transmission image of the liquid crystal panel 100G.

FIG. 2 is a block diagram showing an electrical configuration of the projection display apparatus 1. As shown in the drawing, the projection display apparatus 1 includes a display control circuit 20 and the liquid crystal panels 100R, 100G, and 100B described above.

The display control circuit 20 is supplied with video data Vid_in in synchronization with a synchronization signal Sync from a higher-level apparatus such as a host apparatus (not illustrated). The video data Vid_in is data representing an image to be displayed on the projection display apparatus 1, and specifically, designating gradation levels in pixels of the image in 8 bits for each of R, G, and B in the embodiment.

Note that a pixel of an image designated by the video data Vid_in or correction data of the video data is referred to as a video pixel, and data designating a gradation level of the video pixel is referred to as pixel data, but the video pixel and the pixel data may be described without being particularly distinguished from each other. Further, a pixel that is to be combined by the liquid crystal panel 100R, 100G, or 100B, or a pixel that has been combined by the liquid crystal panel 100R, 100G, or 100B is referred to as a panel pixel. When the video pixels and the panel pixels correspond one-to-one to each other as in the present embodiment, it is not necessary to particularly distinguish the video pixels and the panel pixels from each other.

The synchronization signal Sync includes a signal instructing to start vertical synchronization vertical scanning in the video data Vid_in, a horizontal synchronization signal instructing to start horizontal scanning, and a clock signal representing timing that corresponds to one pixel of the video data.

In the present embodiment, the color image projected on the screen Scr is expressed by superimposing the transmission images of the liquid crystal panels 100R, 100G, and 100B. Therefore, a pixel which is a minimum unit of a color image can be divided into a red panel pixel by the liquid crystal panel 100R, a green panel pixel by the liquid crystal panel 100G, and a blue panel pixel by the liquid crystal panel 100B.

Note that, strictly speaking, the red panel pixel, the green panel pixel, and the blue panel pixel should be referred to as sub-pixels, but are referred to as panel pixels in the present description as described above.

The display control circuit 20 includes a control circuit 21 and processing circuits 22R, 22G, and 22B.

The control circuit 21 generates a control signal Ctr for controlling the liquid crystal panels 100R, 100G, and 100B.

Although details of the processing circuits 22R, 22G, and 22B will be described later, the processing circuit 22R processes video data Va_R of the R component out of the video data Vid_in to convert the video data Va_R into an analog data signal Vid_R, and then supplies the analog data signal Vid_R to the liquid crystal panel 100R.

Similarly, the processing circuit 22G processes video data Va_G of the G component out of the video data Vid_in to convert the video data Va_G into an analog data signal Vid_G, and then supplies the analog data signal Vid_G to the liquid crystal panel 100G. The processing circuit 22B processes video data Va_B of the B component out of the video data Vid_in to convert the video data Va_B into an analog data signal Vid_B, and then supplies the analog data signal Vid_B to the liquid crystal panel 100B.

Note that the liquid crystal display apparatus is conceptually recognized by the liquid crystal panel 100R, 100G, or 100B and the display control circuit 20 that supplies the data signal to the corresponding liquid crystal panel.

Then, the liquid crystal panels 100R, 100G, and 100B will be described. The liquid crystal panels 100R, 100G, and 100B differ only in color, that is, wavelength of the incident light, and are substantially the same in structure. Therefore, the liquid crystal panels 100R, 100G, and 100B are denoted by a reference numeral of 100 when generally described without specifying the color.

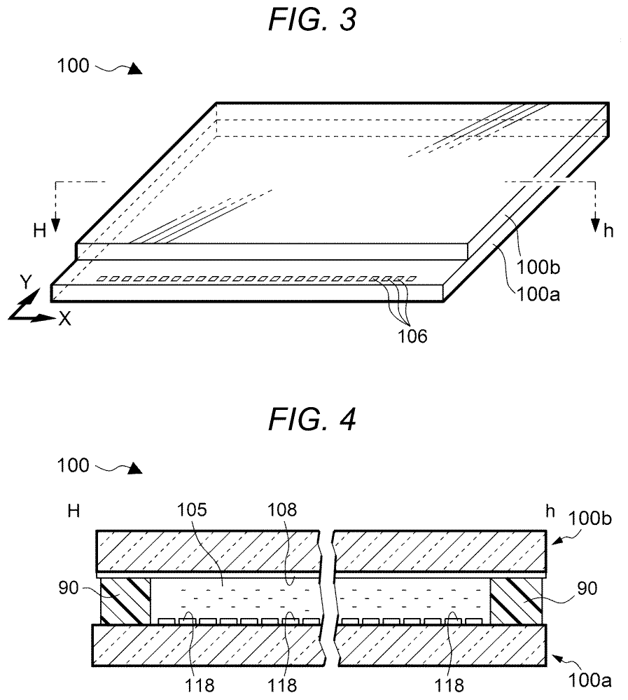

FIG. 3 is a diagram illustrating an essential part of the liquid crystal panel 100, and FIG. 4 is a cross-sectional view of the essential part cut along the line H-h in FIG. 3.

As shown in these drawings, in the liquid crystal panel 100, an element substrate 100a provided with pixel electrodes 118 and an opposed substrate 100b provided with a common electrode 108 are bonded to each other with a sealing material 90 so that the electrode formation surfaces are opposed to each other while keeping a constant gap, and liquid crystal 105 is encapsulated in this gap.

As each of the element substrate 100a and the opposed substrate 100b, a substrate having a light-transmissive property such as glass or quartz is used. As illustrated in FIG. 3, one side of the element substrate 100a projects from the opposed substrate 100b. In this projecting region, a plurality of terminals 106 is arranged along the lateral direction in the drawing. One end of a flexible printed circuit (FPC) board (not illustrated) is coupled to the plurality of terminals 106. Note that the other end of the FPC board is coupled to the display control circuit 20 and is supplied with the various signals described above.

On a surface of the element substrate 100a facing the opposed substrate 100b, the pixel electrodes 118 are formed by patterning a conductive layer having transparency such as indium tin oxide (ITO).

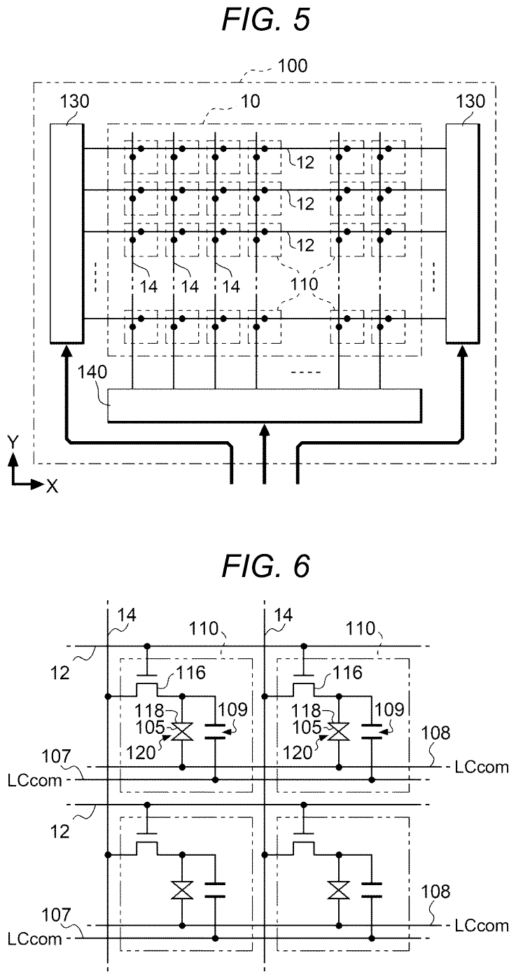

FIG. 5 is a block diagram showing an electrical configuration of the liquid crystal panel 100. In the liquid crystal panel 100, scanning line driving circuits 130 and a data line driving circuit 140 are disposed on a peripheral edge of a display region 10.

In the display region 10 of the liquid crystal panel 100, pixel circuits 110 are arranged in a matrix. Specifically, in the display region 10, a plurality of scanning lines 12 is disposed so as to extend in the X direction as the lateral direction in the drawing, and a plurality of data lines 14 is disposed so as to extend in the Y direction as the longitudinal direction and to keep electrical insulation from the scanning lines 12. Further, the pixel circuits 110 are disposed in a matrix so as to correspond to intersections between the plurality of scanning lines 12 and the plurality of data lines 14.

When the number of scanning lines 12 is represented by m and the number of data lines 14 is represented by n, the pixel circuits 110 are arranged in an m×n matrix. The characters m, n are each an integer no smaller than 2. In the scanning lines 12 and the pixel circuits 110, in order to distinguish the rows of the matrix, the rows may be referred to as 1st, 2nd, 3rd, . . . , (m−1)-th, and m-th rows in this order from the top in the drawing in some cases. Similarly, in the data lines 14 and the pixel circuits 110, in order to distinguish the columns of the matrix, the columns may be referred to as 1st, 2nd, 3rd, . . . , (n−1)-th, and n-th columns in this order from the left in the drawing in some cases.

The scanning line driving circuit 130 selects the scanning lines 12 one by one in the order of, for example, the 1st, 2nd, 3rd, . . . , and m-th rows under the control of the display control circuit 20, and sets the scanning signal to the scanning line 12 thus selected to a H level. Note that the scanning line driving circuit 130 sets the scanning signal to the scanning lines 12 other than the selected scanning line 12 to an L level.

The data line driving circuit 140 latches the data signals that are supplied from the circuit of the corresponding color out of the processing circuits 22R, 22G, and 22B, and that correspond to one row, and outputs the data signals to the pixel circuits 110 located on the scanning line 12 via the data lines 14 in a period in which the scanning signal to that scanning line 12 is at the H level.

FIG. 6 is a diagram illustrating an equivalent circuit of 2×2, totally four pixel circuits 110 corresponding to intersections between the two adjacent scanning lines 12 and the two adjacent data lines 14.

As illustrated in the drawing, the pixel circuit 110 includes a transistor 116 and a liquid crystal element 120. The transistor 116 is, for example, an n-channel thin film transistor. In the pixel circuit 110, a gate node of the transistor 116 is coupled to the scanning line 12, while a source node thereof is coupled to the data line 14, and a drain node thereof is coupled to the pixel electrode 118 having a substantially square planar shape.

The common electrode 108 is disposed commonly to all the pixels so as to be opposed to the pixel electrodes 118. A voltage LCcom is applied to the common electrode 108. Further, as described above, the liquid crystal 105 is sandwiched between the pixel electrode 118 and the common electrode 108. Therefore, the liquid crystal element 120 in which the liquid crystal 105 is sandwiched between the pixel electrode 118 and the common electrode 108 is configured for each pixel circuit 110.

In addition, a storage capacitor 109 is disposed in parallel to the liquid crystal element 120. In the storage capacitor 109, one end is coupled to the pixel electrode 118, and the other end is coupled to a capacitance line 107. A temporally constant voltage, for example, the same voltage LCcom as the voltage applied to the common electrode 108 is applied to the capacitance line 107. Since the pixel circuits 110 are arranged in a matrix over the X direction which is the extending direction of the scanning lines 12 and the Y direction which is the extending direction of the data lines 14, the pixel electrodes 118 provided to the pixel circuits 110 are also arranged over the X direction and the Y direction.

In the scanning line 12 in which the scanning signal is at the H level, the transistor 116 of the pixel circuit 110 provided corresponding to the scanning line 12 is set to an ON-state. Since a state in which the data line 14 and the pixel electrode 118 are electrically coupled to each other is set due to the ON-state of the transistor 116, the data signal supplied to the data line 14 reaches the pixel electrode 118 via the transistor 116 set to the ON-state. When the scanning line 12 becomes at the L level, the transistor 116 is set to an OFF state, but the voltage of the data signal having reached the pixel electrode 118 is held by a capacitive property of the liquid crystal element 120 and the storage capacitor 109.

As is well known, in the liquid crystal element 120, alignment of liquid crystal molecules changes in accordance with an electric field generated by the pixel electrode 118 and the common electrode 108. Therefore, the liquid crystal element 120 is provided with transmittance according to the effective value of the applied voltage.

Note that a region functioning as a panel pixel in the liquid crystal element 120, that is, a region provided with the transmittance according to the effective value of the voltage is a region where the pixel electrode 118 and the common electrode 108 overlap each other in a plan view of the element substrate 100a and the opposed substrate 100b. Since the pixel electrode 118 has a substantially square shape in plan view, the shape of the pixel in the liquid crystal panel 100 is also substantially square.

In addition, in the present embodiment, the liquid crystal 105 is of a vertical alignment (VA) type, and is in a normally black mode in which the transmittance is the lowest when the voltage applied to the liquid crystal element 120 is zero, and the transmittance increases as the applied voltage increases.

An operation of supplying the data signal to the pixel electrode 118 of the liquid crystal element 120 is performed in each horizontal scanning period in the order of 1st, 2nd, 3rd, . . . , and m-th rows. Accordingly, voltages corresponding to the data signals are held in the respective liquid crystal elements 120 of the pixel circuits 110 arranged in the m×n matrix, each of the liquid crystal elements 120 is provided with a target transmittance, and a transmission image of corresponding colors is generated by the liquid crystal elements 120 arranged in the m×n matrix.

In this way, the transmission image is generated for each of R, G, and B, and the color image obtained by combining R, G, and B is projected on the screen Scr.

Then, the processing circuits 22R, 22G, and 22B in FIG. 2 will be described.

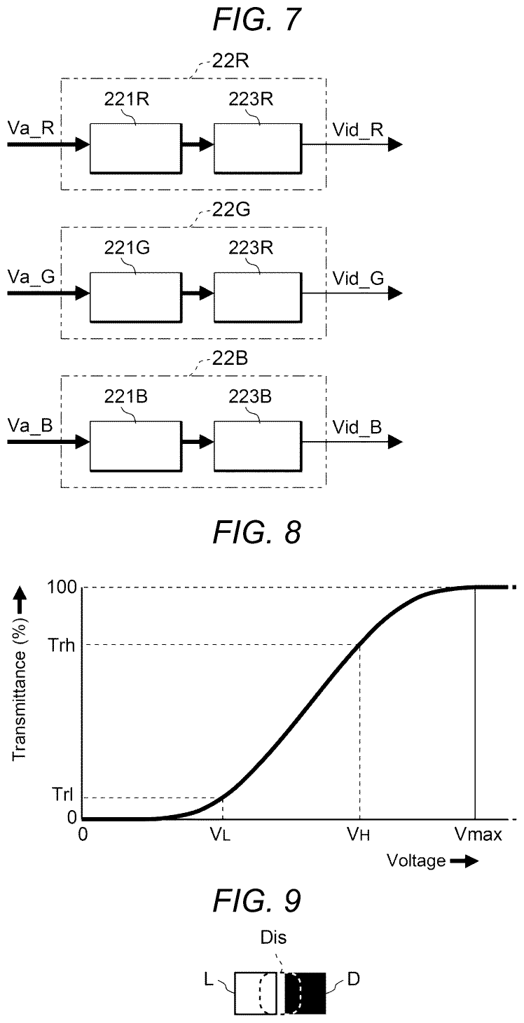

FIG. 7 is a block diagram illustrating a configuration of the processing circuits 22R, 22G, and 22B.

As illustrated in the drawing, the processing circuit 22R includes a smoothing circuit 221R and a restoration circuit 223R.

The smoothing circuit 221R smooths the video data Va_R of the R component so as to reduce a difference between the gradation levels of adjacent video pixels using filter coefficients described later.

The restoration circuit 223R analyzes the video data in which the gradation levels are smoothed by the smoothing circuit 221R, and when the gradation levels of the two adjacent video pixels are within a range of an intermediate gradation, the restoration circuit 223R cancels out the smoothing of the gradation level by the smoothing circuit 221R to restore (bring back) the gradation level to the original gradation level.

Note that a smoothing circuit 221G and a restoration circuit 223G, and a smoothing circuit 221B and a restoration circuit 223B are different only in the color components of the video data to be processed, and are substantially the same in circuit configurations as the smoothing circuit 221R and the restoration circuit 223R in order.

That is, the smoothing circuit 221G and the restoration circuit 223G process the video data Va_G of the G component, and the smoothing circuit 221B and the restoration circuit 223B process the video data Va_B of the B component.

In the following description, when the processing circuits 22R, 22G, and 22B are described without specifying the color component, the processing circuit is denoted by a reference numeral of 22, the smoothing circuit is denoted by a reference numeral of 221, and the restoration circuit is denoted by a reference numeral of 223.

The reason that the gradation level is smoothed by the smoothing circuit 221 will be described.

FIG. 8 is a diagram showing an example of characteristics (V-T characteristics) between the voltage applied to the liquid crystal element 120 and the transmittance in the normally black mode.

In the normally black mode, in the panel pixel in which the high gradation level is designated and the transmittance becomes high, the voltage applied to the liquid crystal element 120 becomes high. Meanwhile, in the panel pixel in which the low gradation level is designated and the transmittance becomes low, the voltage applied to the liquid crystal element 120 becomes low.

For the sake of convenience, in order to describe the disclination, a panel pixel in which the voltage applied to the liquid crystal element 120 is VH or more and the transmittance is Trh is defined as a bright panel pixel. Further, a panel pixel in which the voltage applied to the liquid crystal element 120 is VL or lower and the transmittance is Trl is defined as a dark panel pixel.

The values VH, VL satisfy the following relationship:

VH>VL.

As illustrated in FIG. 9, in the liquid crystal panel 100, when a bright panel pixel L high in transmittance, that is, high in voltage applied to the liquid crystal element 120 and a dark panel pixel D low in transmittance, that is, low in voltage applied to the liquid crystal element 120 are adjacent to each other, a voltage difference between the pixel electrodes 118 becomes high. When the voltage difference between the pixel electrodes 118 becomes high, the lateral electric field generated in a direction along the substrate surface becomes strong, and a phenomenon called disclination in which the alignment of the liquid crystal molecules is disturbed is likely to occur in a region Dis including the boundary between the two panel pixels. The region Dis in which the disclination has occurred is not provided with the transmittance according to the gradation level, which causes a decrease in display quality.

In order to suppress the display defect caused by the disclination, a configuration is conceivable in which a difference in gradation level between the adjacent video pixels is corrected to be small to reduce a voltage difference between the pixel electrodes of the adjacent panel pixels.

The configuration therefor is the smoothing circuit 221. The smoothing circuit 221 accumulates the video data of the corresponding color component by one frame in an internal memory, and smooths the gradation levels of the adjacent video pixels using, for example, the filter coefficients.

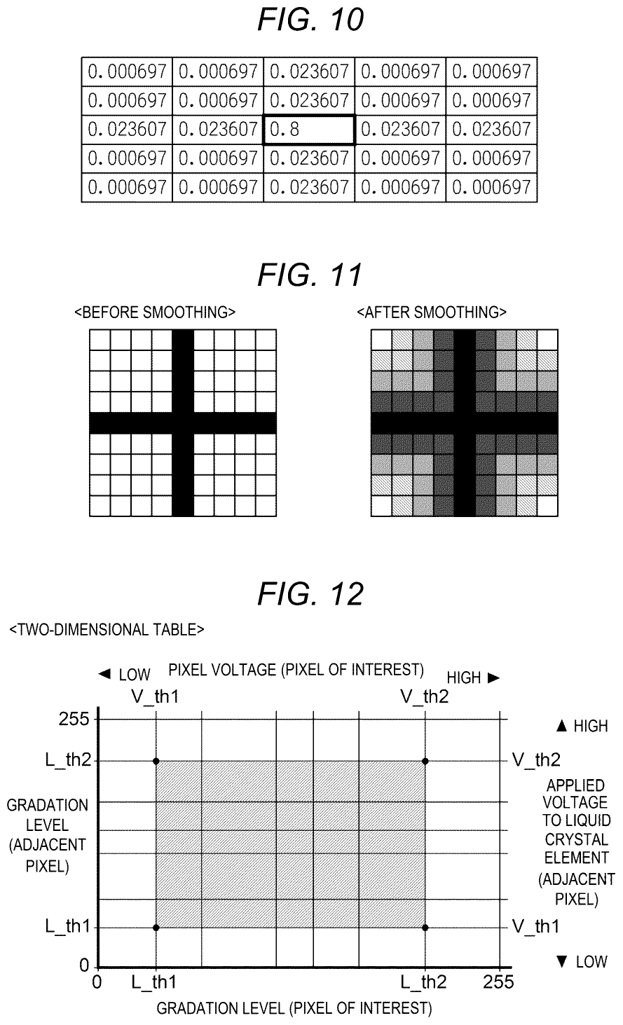

FIG. 10 is a diagram showing an example of a matrix of the filter coefficients (kernels) used for a convolution operation in the smoothing circuit 221.

When the filter coefficients shown in the drawing are used, the video data is processed as follows. That is, in the arrangement of the video pixels constituting the video data, when focusing attention on one video pixel, and when the gradation level of that video pixel of interest is higher than the gradation levels of the surrounding video pixels, the gradation level of the video pixel of interest is reduced by multiplying the gradation level by the coefficient indicated by a thick frame, and the gradation levels of the video pixels located around the video pixel of interest are increased by amounts obtained by multiplying the gradation levels by the coefficients corresponding to the positions, respectively. In addition, when the gradation level of the video pixel of interest is lower than the gradation levels of the surrounding video pixels, the gradation level of the video pixel of interest is increased by multiplying the gradation level by the coefficient indicated by the thick frame, and the gradation levels of the video pixels located around the video pixel of interest are decreased by amounts obtained by multiplying the gradation levels by the coefficients corresponding to the positions, respectively.

FIG. 11 is a diagram illustrating an example of the video pixels before smoothing represented by the video data and an example of the video pixels after smoothing. Note that in the drawing, the gradation level of the video pixel is represented by shading.

In the smoothing circuit 221, when the gradation level of the video pixel of interest corresponds to black and the video pixel located around the video pixel of interest corresponds to white (display of a black character on white background), correction is performed such that the gradation level of the black video pixel as the video pixel of interest greatly increases and the gradation level of the white video pixel located around the video pixel of interest slightly decreases. That is, when a black video pixel and a white video pixel are adjacent to each other, when the number of black video pixels is smaller than the number of white video pixels, relatively weak correction is performed on the white video pixels, and relatively strong correction is performed on the black video pixels.

Note that the black video pixel refers to when the gradation level designated in 8 bits is “0” the lowest in decimal value, and the white video pixel refers to when the gradation level is “255” the highest in decimal value.

Here, when many video pixels whose gradation level corresponds to white are located around the video pixel of interest, including the adjacent video pixel, whose gradation level corresponds to black is referred to as when displaying a black character on white background. This is not a limitation, and when displaying a black character on white background includes when many video pixels whose gradation level is high (bright) are located around the video pixel of interest, including the adjacent video pixel, whose gradation level is low (dark).

Therefore, the black character on white background specifically refers to display in which relatively dark video pixels are arranged as lines, symbols, characters, and the like on a relatively bright video pixels as a background.

On the other hand, when the gradation level of the video pixel of interest corresponds to white and the video pixel located around the video pixel of interest corresponds to black (a white character on black background), correction is performed such that the gradation level of the white video pixel as the video pixel of interest greatly decreases and the gradation level of the black video pixel located around the video pixel of interest slightly increases. That is, when a black video pixel and a white video pixel are adjacent to each other, when the number of black video pixels is larger than the number of white video pixels, relatively strong correction is performed on the white video pixels, and relatively weak correction is performed on the black video pixels.

Here, when many video pixels whose gradation level corresponds to black are located around the video pixel of interest, including the adjacent video pixel, whose gradation level corresponds to white is referred to as when displaying a white character on black background. This is not a limitation, and when displaying a white character on black background includes when many video pixels whose gradation level is low (dark) are located around the video pixel of interest, including the adjacent video pixel, whose gradation level is high (bright).

Therefore, the white character on black background specifically refers to display in which relatively bright video pixels are arranged as characters and the like on a relatively dark video pixels as a background.

In the smoothing of the gradation level by such a smoothing circuit 221, when the gradation level of the video pixel is within the range of the intermediate gradation, the display contradiction is likely to be a problem. When the gradation level is within the range of the intermediate gradation, the difference in the gradation level is small in the first place, but the difference in the gradation level is further reduced by the smoothing and is visually recognized as blur. Therefore, the restoration circuit 223 that executes restoration processing for preventing the display contradiction within the range of the intermediate gradation is provided.

Note that the range of the intermediate gradation mentioned here means a range in which the gradation level is no less than L_th1 and no more than L_th2. The values L_th1, L_th2 are both threshold gradations, and when converted into decimal values, the following relationship is satisfied:

0<L_th1<L_th2<255.

When converting the range of the intermediate gradation into the voltage applied to the liquid crystal element 120, the threshold gradation L_th1 corresponds to the voltage V_th1, and the threshold gradation L_th2 corresponds to the voltage V_th2.

That is, when the gradation level is converted into the voltage applied to the liquid crystal element 120, for example, when the applied voltage corresponding to the black video pixel is 0 V and the applied voltage corresponding to the white video pixel is 5 V, the following relationship is satisfied:

0<V_th1<V_th2<5.

The restoration circuit 223 executes the first restoration processing to fourth restoration processing.

Specifically, the restoration circuit 223
firstly accumulates the video data in which the gradation levels are smoothed by the smoothing circuit 221 in an internal input memory,
secondly focuses attention on one video pixel out of the accumulated video data and specifies a video pixel adjacent in a specific direction (e.g., a right direction) to that video pixel,
thirdly reads restoration amounts corresponding to the gradation data of the video pixel of interest and the gradation data of the video pixel adjacent to the video pixel of interest with reference to the two-dimensional table, and
fourthly adds the restoration amounts thus read out to the gradation data of the video pixel of interest, and accumulates the result in an internal output memory.

The restoration circuit 223 sequentially shifts the video pixel of interest in the video data accumulated in the internal input memory to execute the first processing to the fourth processing on all the video pixels corresponding to one frame. After executing the processing on the video data corresponding to one frame, the restoration circuit 223 executes the first processing to the fourth processing similarly on the video data corresponding to the next frame in substantially the same manner.

FIG. 12 is a diagram showing an example of the two-dimensional table referred to by the restoration circuit 223.

In the two-dimensional table, the gradation level of the video pixel of interest and the gradation level of the video pixel adjacent to the video pixel of interest are input, and the restoration amounts corresponding to the two gradation levels are output.

In the two-dimensional table, the horizontal axis represents the gradation level of the video pixel of interest, and the vertical axis represents the gradation level of the video pixel adjacent to the video pixel of interest. Then, when both the gradation level of the video pixel of interest and the gradation level of the video pixel adjacent to the video pixel of interest are no lower than the threshold gradation L_th1 and no higher than the threshold gradation L_th2, the restoration amount for canceling the smoothing of the gradation level by the smoothing circuit 221 is read out from the two-dimensional table.

Note that in the two-dimensional table, a region in which both the gradation level of the video pixel of interest and the gradation level of the video pixel adjacent to the video pixel of interest are no lower than the threshold gradation L_th1 and no higher than the threshold gradation L_th2 is a hatched region in the drawing.

Further, the restoration amount that is read out when at least one of the gradation level of the video pixel of interest and the gradation level of the video pixel adjacent to the video pixel of interest is lower than the threshold gradation L_th1 or higher than the threshold gradation L_th2 is zero. When the restoration amount of zero is added to the gradation data of the video pixel of interest, the gradation data does not change, that is, the effect of smoothing by the smoothing circuit 221 is maintained.

Note that the video data to which the restoration amount including zero is added is accumulated in the internal output memory. The video data accumulated in the internal output memory is read out at a timing according to the scanning of the liquid crystal panel 100, converted into an analog data signal, and is then output.

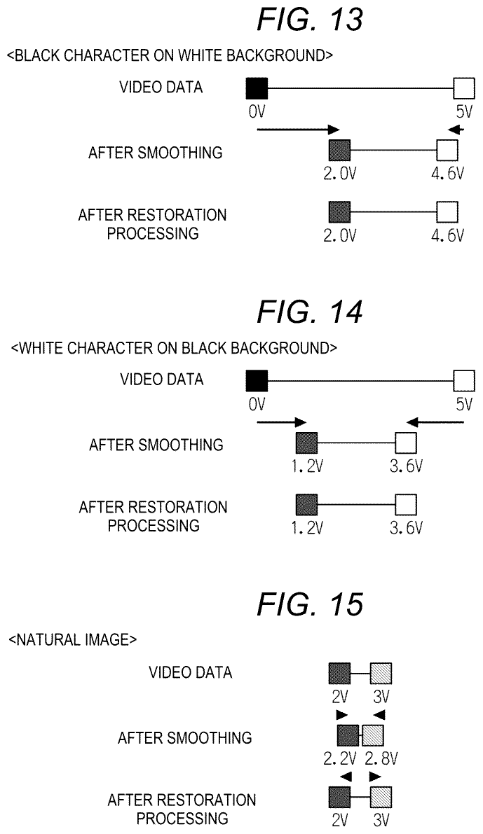

FIGS. 13, 14, and 15 are diagrams illustrating a specific operation of the processing circuit 22 in the first embodiment. Out of these drawings, FIG. 13 is a diagram illustrating the smoothing of the gradation level and the restoration processing on the black video pixel and the white video pixel adjacent to each other when displaying the black character on white background.

FIG. 14 is a diagram illustrating the smoothing of the gradation level and the restoration processing on the black video pixel and the white video pixel adjacent to each other when displaying the white character on black background.

FIG. 15 is a diagram illustrating the smoothing of the gradation level and the restoration processing on the relatively dark video pixel and the relatively bright video pixel adjacent to each other when displaying a natural image.

In FIG. 13, the video data of the black video pixel designates the voltage applied to the liquid crystal element 120 to 0 V before smoothing. In addition, the video data of the white video pixel designates the voltage applied to the liquid crystal element 120 to 5 V before smoothing.

When the gradation level is smoothed by the smoothing circuit 221, the voltage applied to the liquid crystal element 120 corresponding to the black video pixel is corrected so as to increase to, for example, 2.0 V, and the voltage applied to the liquid crystal element 120 corresponding to the white video pixel is corrected so as to decrease to, for example, 4.6 V.

Note that FIG. 13 shows when displaying a black character on white background, that is, when arranging more white video pixels around a black video pixel, and thus, when converting the correction amounts into the applied voltages, the correction amount of the gradation level in the black video pixel is larger than the correction amount of the gradation level in the white video pixel in terms of an absolute value.

In addition, since the gradation level of the black video pixel and the gradation level of the white video pixel before the smoothing are outside the range of the intermediate gradation even after the smoothing, the restoration amount is zero.

Therefore, even after the restoration processing by the restoration circuit 223, the voltage applied to the liquid crystal element 120 corresponding to the black video pixel is 2.0 V, and the voltage applied to the liquid crystal element 120 corresponding to the white video pixel is 4.6 V, which are both not changed from the values after the smoothing.

In FIG. 14, the video data of the black video pixel designates the voltage applied to the liquid crystal element 120 to 0 V before the correction, and the video data of the white video pixel designates the voltage applied to the liquid crystal element 120 to 5 V before the correction.

When the gradation level is smoothed by the smoothing circuit 221, the voltage applied to the liquid crystal element 120 corresponding to the black video pixel is corrected so as to increase to, for example, 1.2 V, and the voltage applied to the liquid crystal element 120 corresponding to the white video pixel is corrected so as to decrease to, for example, 3.6 V.

Note that FIG. 14 shows when displaying a white character on black background, that is, when arranging more black video pixels around a white video pixel, and thus, when converting the correction amounts into the applied voltages, the correction amount of the gradation level in the black video pixel is smaller than the correction amount of the gradation level in the white video pixel in terms of an absolute value.

In addition, since the gradation level of the black video pixel and the gradation level of the white video pixel before the smoothing are outside the range of the intermediate gradation even after the smoothing, the restoration amount is zero.

Therefore, even after the restoration processing by the restoration circuit 223, the voltage applied to the liquid crystal element 120 corresponding to the black video pixel is 1.2 V, and the voltage applied to the liquid crystal element 120 corresponding to the white video pixel is 3.6 V, which are both not changed from the values after the smoothing.

In FIG. 15, in the darker video pixel out of the adjacent video pixels of the intermediate gradation, the voltage applied to the liquid crystal element 120 is designated to, for example, 2.0 V before smoothing. In addition, in the brighter video pixel out of the adjacent video pixels of the intermediate gradation, the voltage applied to the liquid crystal element 120 is designated to, for example, 3.0 V before smoothing.

When the gradation level is smoothed by the smoothing circuit 221, the voltage applied to the liquid crystal element 120 in the darker video pixel having the intermediate gradation is corrected so as to increase to, for example, 2.2 V, and the voltage applied to the liquid crystal element 120 in the brighter video pixel having the intermediate gradation is corrected so as to decrease to, for example, 2.8 V.

Even after the smoothing, the gradation level in the darker video pixel and the gradation level in the brighter video pixel are within the range of the intermediate gradation. Therefore, the smoothing of the gradation level by the smoothing circuit 221 is canceled out by the restoration circuit 223, and the gradation level is restored to the gradation level before the smoothing.

The voltage applied to the liquid crystal element 120 corresponding to the darker video pixel in the intermediate gradation is restored to the original voltage of 2.0 V, and the voltage applied to the liquid crystal element 120 corresponding to the brighter video pixel in the intermediate gradation is restored to the original voltage of 3.0 V.

According to such a first embodiment, when a dark video pixel and a bright video pixel are adjacent to each other, in which the disclination is expected to occur, since smoothing in consideration of surrounding video pixels with respect to the video pixel of interest is maintained, deterioration of display quality due to the disclination can be suppressed. In addition, when the pixels in the intermediate gradation are adjacent to each other, since the smoothing by the smoothing circuit 221 is canceled out by the restoration circuit 223 to prevent the display contradiction from occurring, the blur of the display is suppressed.

The processing contents of the processing circuits 22R, 22G, and 22B in the first embodiment can conceptually be recognized as a display control method. Note that in the processing circuits 22R, 22G, and 22B, as described above, only the color components of the video data to be processed are different, and the processing contents are the same. Therefore, the display control method in the processing circuits 22R, 22G, and 22B will be described as a display control method in the processing circuit 22 without specifying the color component.

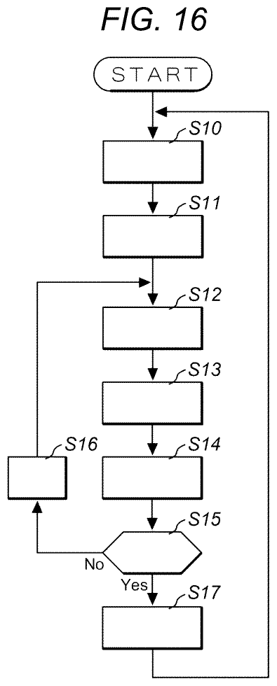

FIG. 16 is a flowchart showing the display control method.

First, in the processing circuit 22, the smoothing circuit 221 smooths the gradation levels of the pixels designated by the video pixels accumulated for one frame (step S10).

Then, in the processing circuit 22, the restoration circuit 223 focuses (step S11) attention on one video pixel in the video data smoothed by the smoothing circuit 221. Then, the restoration circuit 223 specifies (step S12) a video pixel adjacent in a specific direction to the video pixel of interest, and
the restoration circuit 223 reads out (step S13) the restoration amounts corresponding to the gradation level of the video pixel of interest and the gradation level of the specified video pixel with reference to the two-dimensional table, and adds (step S14) the restoration amounts thus read out to the gradation level of the video pixel of interest.

When the gradation levels of the two video pixels are both no lower than the threshold gradation L_th1 and no higher than the threshold gradation L_th2, the restoration amount to be read out is a value that cancels out the smoothing by the smoothing circuit 221 to restore the gradation level of the video pixel of interest to the gradation level before the smoothing.

On the other hand, when at least one of the gradation levels of the two video pixels is lower than the threshold gradation L_th1 or higher than the threshold gradation L_th2, the restoration amount to be read out is zero, and the gradation level of the video pixel of interest is maintained in a state of being smoothed by the smoothing circuit 221.

The restoration circuit 223 determines (step S15) whether attention has been focused on all the video pixels corresponding to one frame. When the determination result is “No”, the restoration circuit 223 shifts (step S16) the video pixel of interest to another video pixel, and returns the process to step S12. Therefore, steps S12 to S16 are repeatedly executed until attention is focused on all the video pixels corresponding to the one frame.

When the determination result in step S15 is “Yes”, which means that attention has been focused on all the video pixels corresponding to the one frame, the processing circuit 22 shifts (step S17) the processing target of the video pixels to the next frame, and returns the process to step S10.

Such processing in steps S11 to S17 is repeatedly executed as long as the video data Vid_in is supplied from the higher-level apparatus (until the power is turned off).

In the first embodiment, when displaying the black character on white background, stronger correction is applied to the dark video pixel than the correction applied to the bright video pixel in smoothing the gradation level. Specifically, in terms of the voltage applied to the liquid crystal element 120, as shown in FIG. 13, since the applied voltage corresponding to the video pixel gradation level of which corresponds to white is corrected from 5.0 V to 4.6 V, the correction amount to be applied is 0.4 V whereas the applied voltage corresponding to the video pixel the gradation level of which corresponds to black is corrected from 0 V to 2.0 V, which means that the correction amount to be applied is 2.0 V which is stronger than that applied to the black video pixel.

In other words, in the first embodiment, when displaying the black character on white background, the correction on the bright video pixel is in a weak state, and the disclination is likely to visually be recognized in the panel pixel expressing that bright video pixel.

Therefore, a second embodiment in which such disclination is suppressed will be described. The projection display apparatus 1 according to the second embodiment is different from that of the first embodiment only in the configurations of the processing circuits 22R, 22G, and 22B. Therefore, in the second embodiment, the processing circuits 22R, 22G, and 22B, which are the differences from the first embodiment, will be described.

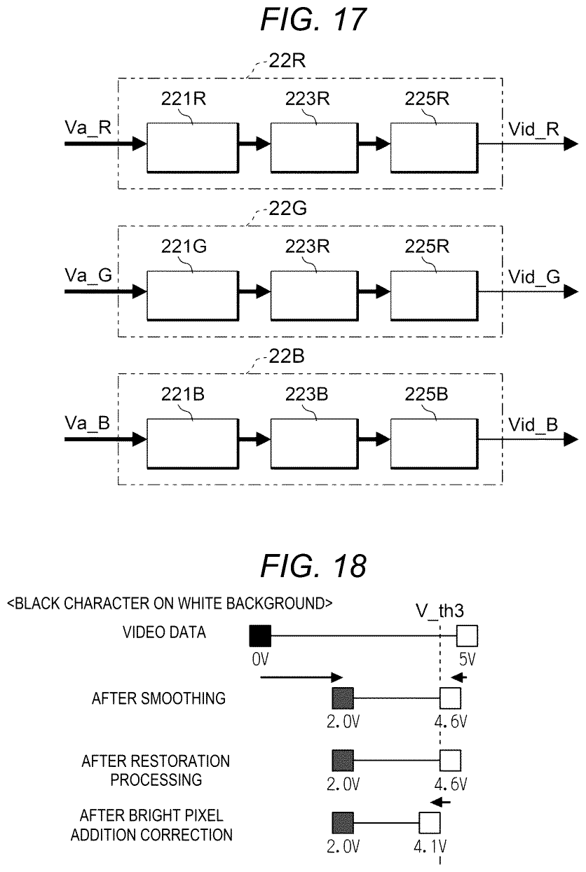

FIG. 17 is block a diagram illustrating configurations of the processing circuits 22R, 22G, and 22B in the second embodiment. In the second embodiment, a correction circuit 225R is disposed at a posterior stage of the restoration circuit 223R in the processing circuit 22R. Similarly, a correction circuit 225G is disposed at a posterior stage of the restoration circuit 223G in the processing circuit 22G, and a correction circuit 225B is disposed at a posterior stage of the restoration circuit 223B in the processing circuit 22B.

The correction circuits 225R, 225G, and 225B are different only in the color component to be processed, and are the same in processing content. Therefore, when describing the correction circuits 225R, 225G, and 225B without specifying the color component, the correction circuit will be denoted by a reference numeral of 225.

The correction circuit 225 focuses attention on one of the video pixels in the video data corresponding to one frame the gradation levels of which are smoothed, added with the restoration amounts, and accumulated in the internal output memory of the restoration circuit 223.

Then, when the threshold gradation is located between the gradation level of the video pixel of interest and the gradation level of the video pixel adjacent in a specific direction (e.g., the right direction) to the video pixel of interest, the correction circuit 225 decreases the gradation level of the video pixel of interest by a predetermined amount. Note that the predetermined amount may be, for example, a constant amount determined in advance, or may be an amount set so that the higher the gradation level of the video pixel of interest than the threshold gradation is, the larger the amount is.

Further, although not particularly illustrated, the threshold gradation is defined as L_th3 for the sake of convenience.

On the other hand, when the threshold gradation L_th3 is not located between the gradation level of the video pixel of interest and the gradation level of the video pixel adjacent to the video pixel of interest, the correction circuit 225 does not perform any processing on the gradation level of the video pixel of interest.

Note that when converting the gradation level into the voltage applied to the liquid crystal element 120, the threshold gradation L_th3 in the correction circuit 225 becomes a threshold voltage V_th3 that satisfies a first condition and a second condition described below.

Specifically, as the first condition, the threshold voltage V_th3 is a voltage lower than a voltage obtained by correcting the voltage applied to the liquid crystal element 120 corresponding to the white video pixel by smoothing the gradation level when the white and black video pixels are adjacent to each other in the display of the black character on white background. Further, as the second condition, the threshold voltage V_th3 is a voltage higher than a voltage obtained by correcting the voltage applied to the liquid crystal element 120 corresponding to the white video pixel by smoothing the gradation level when the white and black video pixels are adjacent to each other in the display of the white character on black background.

Referring to the display examples in FIGS. 13 and 14, the threshold voltage V_th3 in the correction circuit 225 is lower than 4.6 V and higher than 3.6 V.

When the threshold voltage V_th3 is located between the applied voltage corresponding to the dark video pixel and the applied voltage corresponding to the bright video pixel, the correction circuit 225 reduces the gradation level of the bright video pixel by a predetermined amount.

Note that this is an example of the threshold voltage V_th3, and the threshold voltage V_th3 is actually set to a voltage at which the disclination to visually be recognized is not noticeable.

The correction circuit 225 accumulates, in an internal output memory, the video data the gradation level of which is lowered or the video data on which the processing was not performed. The video data accumulated in the internal output memory is read out at a timing according to the scanning of the liquid crystal panel 100, converted into an analog data signal, and is then output.

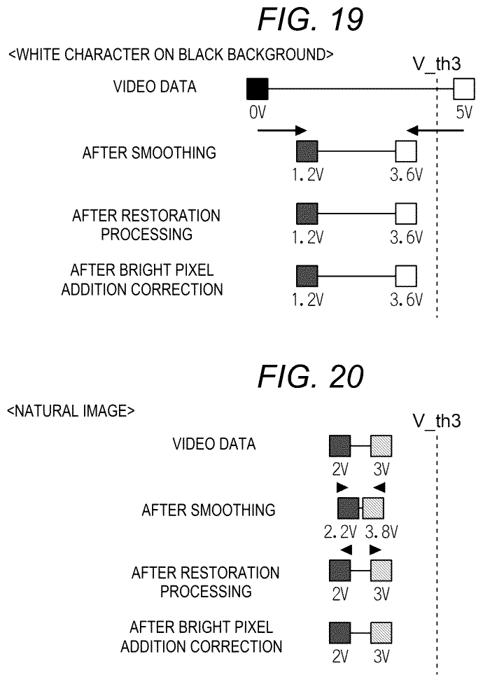

FIGS. 18, 19, and 20 are diagrams illustrating a specific operation of the processing circuit 22 in the second embodiment. In these drawings, FIG. 18 is a diagram showing when displaying the black character on white background similarly to FIG. 13, FIG. 19 is a diagram showing when displaying the white character on black background similarly to FIG. 14, and FIG. 20 is a diagram showing when displaying the natural image similarly to FIG. 15.

In FIG. 18, when displaying the black character on white background, the voltage applied to the liquid crystal element 120 before the smoothing is applied, the voltage applied to the liquid crystal element 120 after the smoothing is applied, and the voltage applied to the liquid crystal element 120 after the restoration processing is performed in each of the black and white video pixels are substantially the same as those in FIG. 13.

Here, when displaying the black character on white background, the voltage applied to the liquid crystal element 120 after the restoration processing is performed in the black video pixel is 2.0 V. In addition, in the white video pixel, the voltage applied to the liquid crystal element 120 after the restoration processing is performed is 4.6 V.

Since the threshold voltage V_th3 is located between 2.0 V and 4.6 V, the gradation level of the white video pixel is decreased by smoothing and does not change in the restoration processing, but is decreased by the correction by the correction circuit 225.

FIG. 18 shows an example in which the voltage applied to the liquid crystal element 120 in the white video pixel is reduced from 4.6 V that is the value after the restoration processing is performed to 4.1 V when displaying the black character on white background.

Note that, in the correction circuit 225, since the darker video pixel, here, the black video pixel is not the correction target, in the black video pixel, the voltage applied to the liquid crystal element 120 is not changed by the correction from 2.0 V that is the value after the restoration processing is performed.

In FIG. 19, when displaying the white character on black background, the voltage applied to the liquid crystal element 120 before the smoothing is applied, the voltage applied to the liquid crystal element 120 after being smoothed, and the voltage applied to the liquid crystal element 120 after the restoration processing is performed in each of the black and white video pixels are substantially the same as those in FIG. 14.

Here, when displaying the white character on black background, the voltage applied to the liquid crystal element 120 after the restoration processing is performed in the black video pixel is 1.2 V. In addition, in the white video pixel, the voltage applied to the liquid crystal element 120 after the restoration processing is performed is 3.6 V.

Since the threshold voltage V_th3 is not located between 1.2 V and 3.6 V, the gradation level of the white video pixel is not corrected by the correction circuit 225. Therefore, when displaying the white character on black background, the voltage applied to the liquid crystal element 120 in the white video pixel does not change from 3.6 V that is the value after the restoration processing.

In FIG. 20, when displaying the natural image, the voltage applied to the liquid crystal element 120 before the smoothing is applied, the voltage applied to the liquid crystal element 120 after being smoothed, and the voltage applied to the liquid crystal element 120 after the restoration processing is performed in each of the bright video pixel and the dark video pixel are substantially the same as those in FIG. 15.

Here, when displaying the natural image, the voltage applied to the liquid crystal element 120 for the dark video data after the restoration processing is 2.0 V. Further, for the bright video data, the voltage applied to the liquid crystal element 120 after the restoration processing is 3.0 V.

Since the threshold voltage V_th3 is not located between 2.0 V and 3.0 V, the gradation level of the bright video data is not corrected by the correction circuit 225. Therefore, when displaying the natural image, the voltage applied to the liquid crystal element 120 for the bright video data does not change from 3.0V that is the value after the restoration processing.

According to such a second embodiment, similarly to the first embodiment, when a dark video pixel and a bright video pixel are adjacent to each other, since smoothing in consideration of surrounding video pixels with respect to the video pixel of interest is maintained, deterioration of display quality due to the disclination can be suppressed. In addition, when the pixels in the intermediate gradation are adjacent to each other, since the smoothing by the smoothing circuit 221 is canceled out by the restoration circuit 223 to prevent the display contradiction from occurring, the blur of the display is suppressed.

Further, in the second embodiment, in the display in which the bright video pixels are the background with respect to the dark video pixel, since the correction processing is performed on the bright video pixel adjacent to the dark video pixel after the smoothing, the disclination can be suppressed compared to the first embodiment.

The processing contents of the processing circuits 22R, 22G, and 22B in the second embodiment can conceptually be recognized as a display control method similarly to the first embodiment.

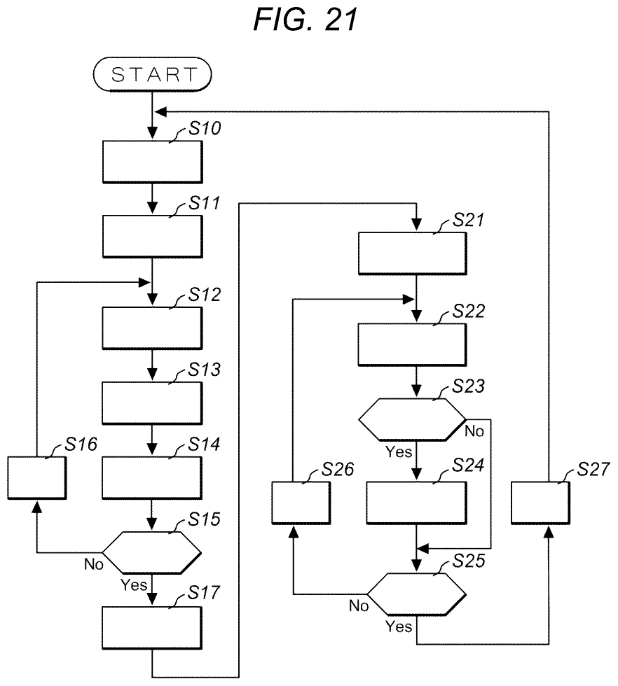

FIG. 21 is a flowchart showing the display control method. In FIG. 21, the correction processing in the correction circuit 225 is added to FIG. 16 after the restoration processing for one frame. The correction processing added thereto will be described.

In the processing circuit 22, the correction circuit 225 focuses (step S21) attention on one video pixel in the video data corresponding to one frame in which the restoration amounts (including zero) are added by the restoration circuit 223. Then, the correction circuit 225 specifies (step S22) a video pixel adjacent in the specific direction to the video pixel of interest.

The correction circuit 225 determines (step S23) whether the threshold gradation L_th3 is located between the gradation level of the video pixel of interest and the gradation level of the specified video pixel.

When the determination result is “Yes”, the correction circuit 225 decreases (step S24) the gradation level of the video pixel of interest by a predetermined amount.

On the other hand, when the determination result is “No”, the correction circuit 225 skips the process to step S25 without performing any processing on the gradation level of the video pixel of interest.

After step S24, or when the determination result in step S23 is “No”, the correction circuit 225 determines (step S25) whether attention has been focused on all the video pixels corresponding to the one frame. When the determination result is “No”, the correction circuit 225 shifts (step S26) the video pixel of interest to another video pixel, and returns the process to step S22.

Therefore, also in the correction circuit 225, steps S21 to S26 are repeatedly executed until attention is focused on all the video pixels corresponding to the one frame.

When the determination result in step S25 is “Yes”, which means that attention has been focused on all the video pixels corresponding to the one frame, the processing circuit 22 shifts (step S27) the processing of the video pixels to the next frame, and returns the process to step S10.

Such processing in steps S10 to S17 and S21 to S27 is repeatedly executed as long as the video data Vid_in is supplied from the higher-level apparatus (until the power is turned off).

Note that the liquid crystal display apparatus is also applicable to electronic apparatuses other than the projection display apparatus 1. For example, the liquid crystal display apparatus is also applicable to a head-mounted display, an electronic viewfinder in a video camera or a lens-interchangeable digital camera, a display unit of a portable information terminal or a wristwatch and so on.

The following aspects, for example, are figured out from the above embodiments.

A liquid crystal display apparatus according to Aspect 1 includes a liquid crystal panel including panel pixels, and a display control circuit configured to control the liquid crystal panel, wherein gradation levels of video pixels constituting video data are designated by pixel data, the video pixels include a first video pixel and a first adjacent video pixel adjacent to the first video pixel, and the display control circuit is configured to supply a data signal having a voltage based on a gradation level designated by the pixel data of the first video pixel to the panel pixel corresponding to the first video pixel, supply a data signal having a voltage based on a gradation level designated by the pixel data of the first adjacent video pixel to the panel pixel corresponding to the first adjacent video pixel, and make a voltage of a data signal supplied to the panel pixel in accordance with the first video pixel when both a gradation level designated by the pixel data of the first video pixel and a gradation level designated by the pixel data of the first adjacent video pixel are within an intermediate gradation range no lower than a first threshold gradation and no higher than a second threshold gradation, and a voltage of a data signal supplied to the panel pixel in accordance with the first video pixel when at least one of a gradation level of the first video pixel and a gradation level of the first adjacent video pixel is out of the intermediate gradation range different from each other.

According to the liquid crystal display apparatus related to Aspect 1, it becomes possible to suppress the blur of the display that occurs in the intermediate gradation.

Note that when focusing attention on a certain video pixel, the video pixel of interest is an example of the “first video pixel”, and a video pixel adjacent rightward to the video pixel of interest is an example of the “first adjacent video pixel”. The threshold gradation L_th1 is an example of the “first threshold gradation”, and the threshold gradation L_th2 is an example of the “second threshold gradation”.

In addition, “adjacent” simply refers to being adjacent to each other, and includes when not being in contact with each other.

In the liquid crystal display apparatus according to Aspect 2 specific to Aspect 1, the video pixels include a second adjacent video pixel other than the first adjacent video pixel and adjacent to the first video pixel, and the display control circuit is configured to smooth a gradation level designated by the pixel data of the first video pixel based on a gradation level designated by the pixel data of the first adjacent video pixel and a gradation level designated by the pixel data of the second adjacent video pixel, and then determine whether the gradation level designated by the pixel data of the first video pixel and the gradation level designated by the pixel data of the first adjacent video pixel are within the intermediate gradation range or out of the intermediate gradation range.

According to the liquid crystal display apparatus related to Aspect 2, it becomes possible to suppress the deterioration of display quality due to the disclination to suppress the blur of display that occurs in the intermediate gradation.

Note that the video pixel adjacent leftward, rightward, upward, or downward to the video pixel of interest is an example of the “second adjacent video pixel”.

In the liquid crystal display apparatus according to Aspect 3 specific to Aspect 2, when a gradation level smoothed for the first video pixel is higher than a gradation level smoothed for the first adjacent video pixel and at least one of the gradation level smoothed for the first video pixel and the gradation level smoothed for the first adjacent video pixel is out of the intermediate gradation range, the display control circuit lowers the gradation level smoothed for the first video pixel.

According to the liquid crystal display apparatus related to Aspect 3, it is possible to suppress the disclination that is likely to visually be recognized corresponding to a bright video pixel.

A liquid crystal display apparatus according to another Aspect 4 includes a liquid crystal panel having panel pixels, and a display control circuit that controls the liquid crystal panel, wherein video pixels constituting video data are arranged in a first direction and a second direction, gradation levels of the video pixels are designated by pixel data, and the display control circuit is configured to perform first correction on the pixel data of one of the video pixels based on the pixel data of two or more of the video pixels adjacent in the first direction, a direction opposite to the first direction, the second direction, or a direction opposite to the second direction to the one of the video pixels, determine whether both a voltage according to a gradation level of the pixel data of a video pixel of interest out of the pixel data on which the first correction was performed, and a voltage according to a gradation level of the pixel data of a video pixel adjacent in the first direction or the second direction to the video pixel of interest out of the pixel data on which the first correction was performed are in an intermediate gradation range no lower than a first threshold voltage and no higher than a second threshold voltage, perform second correction of cancelling out the first correction performed on the pixel data of the video pixel of interest when both the voltages are within the intermediate gradation range, and supply the panel pixel with a data signal based on the pixel data on which the first correction was performed or, when the second correction was performed, the pixel data on which the second correction was performed.

According to the liquid crystal display apparatus related to Aspect 4, it becomes possible to suppress the deterioration of display quality due to the disclination to suppress the blur of display that occurs in the intermediate gradation.

Note that a rightward direction is an example of the “first direction”, a leftward direction is an example of the “direction opposite to the first direction”, a downward direction is an example of the “second direction”, and an upward direction is an example of the “direction opposite to the second direction”.

The voltage V_th1 is an example of the “first threshold voltage”, and the voltage V_th2 is an example of the “second threshold voltage”. The smoothing processing is an example of the “first correction”, and the restoration processing is an example of the “second correction”.

A method of controlling a liquid crystal display apparatus according to Aspect 5 is a method of controlling a liquid crystal display apparatus including a liquid crystal panel including panel pixels, and a display control circuit configured to control the liquid crystal panel, wherein gradation levels of video pixels constituting video data are designated by pixel data, and the video pixels include a first video pixel and a first adjacent video pixel adjacent to the first video pixel, the method including supplying a data signal having a voltage based on gradation level designated by the pixel data of the first video pixel to the panel pixel corresponding to the first video pixel, supplying a data signal having a voltage based on a gradation level designated by the pixel data of the first adjacent video pixel to the panel pixel corresponding to the first adjacent video pixel, and making a voltage of a data signal supplied to the panel pixel in accordance with the first video pixel when both a gradation level designated by the pixel data of the first video pixel and a gradation level designated by the pixel data of the first adjacent video pixel are within an intermediate gradation range no lower than a first threshold gradation and no higher than a second threshold gradation, and a voltage of a data signal supplied to the panel pixel in accordance with the first video pixel when at least one of a gradation level of the first video pixel and a gradation level of the first adjacent video pixel is out of the intermediate gradation range different from each other.

According to the method of controlling the liquid crystal display apparatus related to Aspect 5, it becomes possible to suppress the blur of the display that occurs in the intermediate gradation.

An electronic apparatus according to Aspect 6 includes the liquid crystal display apparatus according to any one of Aspects 1 to 4.

What is claimed is:

1. A liquid crystal display apparatus comprising:
a liquid crystal panel including panel pixels; and
a display control circuit configured to control the liquid crystal panel, wherein
gradation levels of video pixels constituting video data are designated by pixel data,
the video pixels include a first video pixel and a first adjacent video pixel adjacent to the first video pixel, and
the display control circuit is configured to
supply a data signal having a voltage based on a gradation level designated by the pixel data of the first video pixel to the panel pixel corresponding to the first video pixel,
supply a data signal having a voltage based on a gradation level designated by the pixel data of the first adjacent video pixel to the panel pixel corresponding to the first adjacent video pixel, and
make a voltage of a data signal supplied to the panel pixel in accordance with the first video pixel when both a gradation level designated by the pixel data of the first video pixel and a gradation level designated by the pixel data of the first adjacent video pixel are within an intermediate gradation range no lower than a first threshold gradation and no higher than a second threshold gradation, and a voltage of a data signal supplied to the panel pixel in accordance with the first video pixel when at least one of a gradation level of the first video pixel and a gradation level of the first adjacent video pixel is out of the intermediate gradation range different from each other.

2. The liquid crystal display apparatus according to claim 1, wherein
the video pixels include a second adjacent video pixel other than the first adjacent video pixel and adjacent to the first video pixel, and
the display control circuit is configured to
smooth a gradation level designated by the pixel data of the first video pixel based on a gradation level designated by the pixel data of the first adjacent video pixel and a gradation level designated by the pixel data of the second adjacent video pixel, and then
determine whether the gradation level designated by the pixel data of the first video pixel and the gradation level designated by the pixel data of the first adjacent video pixel are within the intermediate gradation range or out of the intermediate gradation range.

3. The liquid crystal display apparatus according to claim 2, wherein
when a gradation level smoothed for the first video pixel is higher than a gradation level smoothed for the first adjacent video pixel and
at least one of the gradation level smoothed for the first video pixel and the gradation level smoothed for the first adjacent video pixel is out of the intermediate gradation range,
the display control circuit lowers the gradation level smoothed for the first video pixel.

4. A liquid crystal display apparatus comprising:
a liquid crystal panel having panel pixels; and
a display control circuit that controls the liquid crystal panel, wherein
video pixels constituting video data are arranged in a first direction and a second direction,
gradation levels of the video pixels are designated by pixel data, and
the display control circuit is configured to
perform first correction on the pixel data of one of the video pixels based on the pixel data of two or more of the video pixels adjacent in the first direction, a direction opposite to the first direction, the second direction, or a direction opposite to the second direction to the one of the video pixels,
determine whether both a voltage according to a gradation level of the pixel data of a video pixel of interest out of the pixel data on which the first correction was performed, and a voltage according to a gradation level of the pixel data of a video pixel adjacent in the first direction or the second direction to the video pixel of interest out of the pixel data on which the first correction was performed are in an intermediate gradation range no lower than a first threshold voltage and no higher than a second threshold voltage,
perform second correction of cancelling out the first correction performed on the pixel data of the video pixel of interest when both the voltages are within the intermediate gradation range, and
supply the panel pixel with a data signal based on the pixel data on which the first correction was performed or, when the second correction was performed, the pixel data on which the second correction was performed.

5. A method of controlling a liquid crystal display apparatus including
a liquid crystal panel including panel pixels, and
a display control circuit configured to control the liquid crystal panel, wherein
gradation levels of video pixels constituting video data are designated by pixel data, and
the video pixels include a first video pixel and a first adjacent video pixel adjacent to the first video pixel,
the method comprising:
supplying a data signal having a voltage based on a gradation level designated by the pixel data of the first video pixel to the panel pixel corresponding to the first video pixel;
supplying a data signal having a voltage based on a gradation level designated by the pixel data of the first adjacent video pixel to the panel pixel corresponding to the first adjacent video pixel; and
making a voltage of a data signal supplied to the panel pixel in accordance with the first video pixel when both a gradation level designated by the pixel data of the first video pixel and a gradation level designated by the pixel data of the first adjacent video pixel are within an intermediate gradation range no lower than a first threshold gradation and no higher than a second threshold gradation, and a voltage of a data signal supplied to the panel pixel in accordance with the first video pixel when at least one of a gradation level of the first video pixel and a gradation level of the first adjacent video pixel is out of the intermediate gradation range different from each other.

6. An electronic apparatus comprising
the liquid crystal display apparatus according to claim 1.
